(19) United States
(12) Patent Application Publication
(10) Pub. No.: US 2018/0039822 A1
(43) Pub. Date: Feb. 8, 2018

(54) LEARNING DEVICE AND LEARNING DISCRIMINATION SYSTEM

(71) Applicant: MITSUBISHI ELECTRIC CORPORATION, Tokyo (JP)

(72) Inventors: Takayuki SEMITSU, Tokyo (JP); Nobuaki MOTOYAMA, Tokyo (JP); Shunichi SEKIGUCHI, Tokyo (JP)

(73) Assignee: MITSUBISHI ELECTRIC CORPORATION, Tokyo (JP)

(21) Appl. No.: 15/554,534

(22) PCT Filed: Aug. 20, 2015
(86) PCT No.: PCT/JP2015/073374

§ 371 Date: Aug. 30, 2017

(51) Int. Cl. G06K 9/00; G06K 9/72; G06F 17/30; G06N 3/08

(52) U.S. Cl. CPC G06K 9/00268; G06K 9/00288; G06N 3/08; G06K 9/00308; G06K 9/72; G06F 17/30256

(57) ABSTRACT

A learning sample collector is configured to collect learning samples which have been classified into respective classes through N-classes discrimination (N is a natural number of 3 or more). A classifier is configured to reclassify the learning samples collected by the learning sample collector into classes applied to M-classes discrimination, where M is smaller than N (M is a natural number of 2 or more and is less than N). A learner is configured to learn a discriminator for performing the M-classes discrimination on a basis of the learning samples reclassified by the classifier.

### TECHNICAL FIELD

The present invention relates to a learning device that learns a discriminator for discriminating, for example, a class to which a targeted object in an image belongs, and also relates to a learning discrimination system.

### BACKGROUND ART

In an image processing technique field, technique of pattern discrimination is actively researched and developed to discriminate a targeted object in an image by performing feature extraction on image data and learning a pattern specified by a feature vector extracted from the image data.

In feature extraction, a pixel value of the image data may be directly extracted as the feature vector. Alternatively, data obtained by processing an image may be used as the feature vector. Generally, since feature quantity obtained by such feature extraction becomes data of multiple dimensions, the feature quantity is called a feature vector. Note that feature quantity may be data of a single dimension.

For example, Non-patent Literature (hereinafter, “NPTL”) 1 describes technique to find, as a histogram, frequencies of density levels in an image. Such processing is also an instance of the above feature extraction processing.

For image discrimination processing, a large number of learning methods using supervised learning have been proposed, which is one type of learning in pattern discrimination. Supervised learning is a learning method performed by preparing a learning sample given with a label corresponding to an input image and finding, based on this learning sample, a calculation formula for estimating a corresponding label from an image or a feature vector.

The NPTL 1 describes image discrimination processing using a nearest neighbor method which is one type of the supervised learning. The nearest neighbor method is performed by finding a distance from each class in a feature space as a classifier and determining a class having the shortest distance as a belonging class.

In this method, a plurality of classes of image data is required. Generally, it becomes more difficult to perform discrimination as quantity of class increases, while it becomes easier as quantity of class are fewer.

NPTL 2 describes a method for learning a facial expression captured in an image by using a neural network called convolutional neural networks (hereinafter referred to as “CNN”). In this method, a probability of belonging to each class is found for an image to be classified, and a class having the highest probability is determined as the class to which the image belongs.

Furthermore, NPTL 3 describes facial expression discrimination for recognizing a facial expression of a person captured in an image. In facial expression discrimination, a facial expression of a person captured in an image is generally classified as one of seven-classes of joy, sadness, anger, straight face, astonishment, fear, and dislike. A discrimination result indicating that a facial expression of a person captured in an image has a joy level of 80 is obtained, for example. Alternatively, as an output form of the facial expression discrimination, a certainty factor may be found for each of the seven-classes. In either case, a criterion indicating which class an image to be discriminated belongs to is set.

### CITATION LIST

NPTL 1: Supervised by Takagi Mikio and Shimoda Haruhisa (2004) Shinpen Gazoukaiseki Handbook, University of Tokyo Press, pp. 1600-1603.
NPTL 2: Wei Li, Min Li, Zhong Su, Zhigang Zhu, “A Deep-Learning Approach to Facial Expression Recognition with Candid Images”, 14th IAPR Conference on Machine Vision Applications (MVA 2015), pp. 279-282, Tokyo.
NPTL 3: Michael Lyons, Shigeru Akamatsu, Miyuki Kamachi, Jiro Gyoba, “Coding Facial Expressions with Gabor Wavelets”, 3rd IEEE International Conference on Automatic Face and Gesture Recognition, pp. 200-205, 1998.

### SUMMARY OF INVENTION

In a field to which such discrimination technique is applied, there may be cases where it is desired to obtain a discrimination result with less class by using learning samples which have been classified into respective classes through multiple class discrimination.

For example, in the facial expression discrimination of an image of a person looking at an advertisement, there is a case where it is desired to detect whether or not a facial expression of the person looking at the advertisement is affirmative from a discrimination result classified into seven-classes (joy, sadness, anger, straight face, astonishment, fear, and dislike) in order to determine effects of the advertisement.

However, in an N-classes discrimination problem (N is a natural number of 3 or more), a discrimination result is obtained based on a discrimination criterion of each class. Hence, when a discrimination criterion of an M-classes discrimination problem, where M is smaller than N (M is a natural number of 2 or more and is less than N), is applied to a result of the N-classes discrimination, it is not possible to determine what value the result of the N-classes discrimination will take. Further, when a result of the N-classes discrimination is quantified for each class, discrimination results of different classes cannot be compared through the discrimination criterion of the M-classes discrimination.

In this manner, conventionally, results of the N-classes discrimination cannot be compared as being the M-classes discrimination problem.

This invention has been made to resolve the above problem with an object of obtaining a learning device and a learning discrimination system capable of comparing results of the N-classes discrimination by a discrimination criterion of the M-classes discrimination problem that M is smaller than N.

A learning device according to the present invention includes a learning sample collector, a classifier, and a learner. The learning sample collector is configured to collect learning samples which have been classified into respective classes through N-classes discrimination. The classifier is configured to reclassify the learning samples collected by the learning sample collector into classes applied to M-classes discrimination, where M is smaller than N. The learner is configured to learn a discriminator for performing the M-classes discrimination on a basis of the learning samples reclassified by the classifier.

According to this invention, learning samples having been classified into the respective classes through N-classes discrimination are reclassified into classes of M-classes discrimination, where M is smaller than N, and a discriminator which gives a discrimination criterion of the M-classes discrimination is learned. Therefore, results of the N-classes discrimination can be compared through a discrimination criterion of the M-classes discrimination problem, where M is smaller than N.

### BRIEF DESCRIPTION OF DRAWINGS

FIG. 1 is a diagram illustrating an overview of image discrimination in facial expression discrimination.

FIG. 2 is a diagram illustrating a point at issue in a case where results of seven-classes discrimination in facial expression discrimination are compared through a discrimination criterion of two-classes discrimination.

FIG. 3 is a diagram illustrating a feature space where six-classes are defined.

FIG. 4 is a diagram illustrating the feature space in FIG. 3 where discrimination boundaries are set among classes.

FIG. 5 is a block diagram illustrating a functional configuration of a learning discrimination system according to Embodiment 1 of the invention.

FIGS. 6A and 6B are block diagrams illustrating the hardware constitution of a learning device according to the Embodiment 1. FIG. 6A is a diagram illustrating processing circuitry of hardware implementing functions of the learning device. FIG. 6B is a diagram illustrating the hardware constitution that executes software implementing functions of the learning device.

FIG. 7 is a flowchart illustrating operations of the learning device according to the Embodiment 1.

FIGS. 8A and 8B are diagrams illustrating an overview of processing for performing two-classes discrimination using a result of seven-classes discrimination in facial expression discrimination. FIG. 8A is a diagram illustrating learning samples reclassified from seven classes to two classes. FIG. 8B is a diagram illustrating a result of two-classes discrimination.

FIG. 9 is a block diagram illustrating a functional configuration of a learning device according to Embodiment 2 of the invention.

FIG. 10 is a flowchart illustrating operations of the learning device according to the Embodiment 2.

FIGS. 11A and 11B are diagrams illustrating processing for adjusting the ratio of the quantity of learning samples between classes. FIG. 11A is a case where the quantity of samples is not adjusted. FIG. 11B is a case where the quantity of samples is adjusted.

### DESCRIPTION OF EMBODIMENTS

In order to describe the invention further in detail, embodiments for carrying out the invention will be described below along the accompanying drawings.

### Embodiment 1

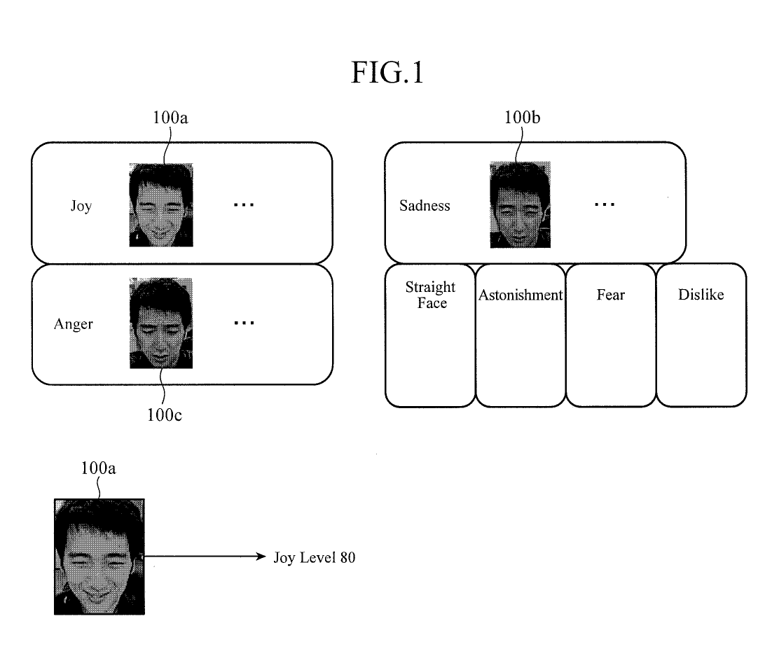

FIG. 1 is a diagram illustrating an overview of image discrimination in facial expression discrimination. In facial expression discrimination, seven pieces of classification labels for joy, sadness, anger, straight face, astonishment, fear, and dislike are common as described above, and thus N=7 holds. In this seven-classes discrimination problem, an image to be discriminated is classified as a class of a discriminator, which outputs the highest discrimination score after the image is input to discriminators of respective classes, and discrimination results are obtained through a discrimination criterion of each of the classes.

In FIG. 1, an image 100a is classified as a class of the label “joy”, an image 100b is classified as a class of the label “sadness”, and an image 100c is classified as a class of the label “anger”. With regard to the image 100a, “joy level 80” for example is output as a discrimination result. The joy level corresponds to a certainty factor indicating a degree that an image to be discriminated belongs to the class of label “joy”. The joy level may take a value from 0 to 100.

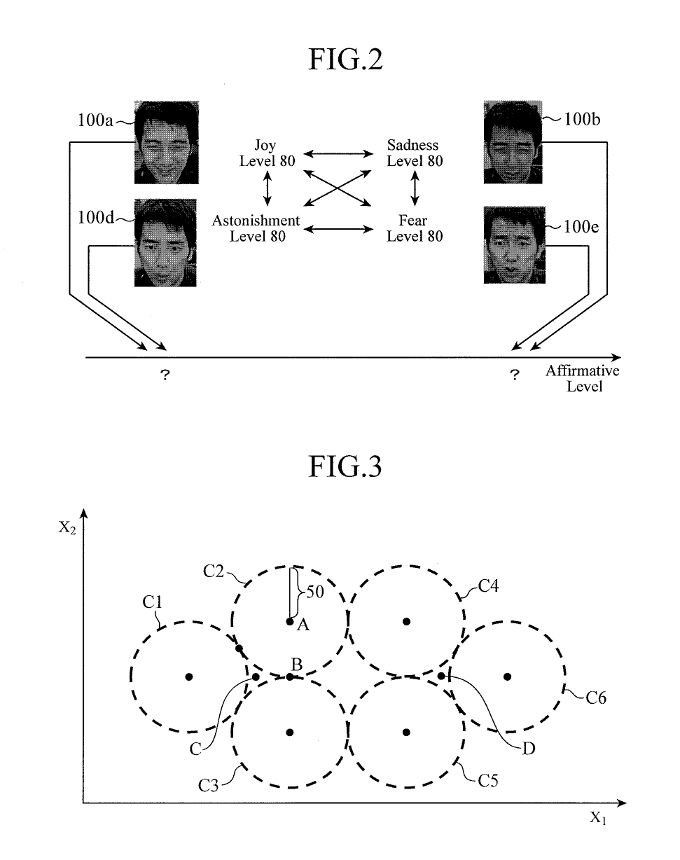

FIG. 2 is a diagram illustrating a point at issue in a case where results of seven-classes discrimination of facial expression discrimination are compared through a discrimination criterion of two-classes discrimination. In FIG. 2, it is assumed that discrimination results of “joy level 80”, “sadness level 80”, “astonishment level 80”, and “fear level 80” are obtained for the image 100a, the image 100b, an image 100d, and an image 100e, respectively, by the seven-classes discrimination of facial expression discrimination. Note that a sadness level corresponds to a certainty factor indicating a degree that an image to be discriminated belongs to the class of label “sadness”. The sadness level may take a value from 0 to 100. An astonishment level corresponds to a certainty factor indicating a degree that an image to be discriminated belongs to the class of label “astonishment”. The astonishment level may take a value from 0 to 100. A fear level corresponds to a certainty factor indicating a degree that an image to be discriminated belongs to a class of label “fear”. The fear level may take a value from 0 to 100.

It is assumed here that a two-classes discrimination problem “whether a facial expression is affirmative” is applied to the discrimination results of the seven-classes discrimination problem as to joy, sadness, anger, straight face, astonishment, fear, and dislike in facial expression discrimination.

In this case, it is required to compare respective discrimination results in the seven-classes discrimination problem through the discrimination criterion of “whether a facial expression is affirmative”.

However, the respective discrimination results of the seven-classes discrimination problem have been determined through a discrimination criterion for each class applied to the seven-classes discrimination problem, and thus cannot be compared through the discrimination criterion of “whether a facial expression is affirmative”.

More specifically, for instance, it may be hard to determine which of the discrimination results of the joy level 80 or the astonishment level 80 is more affirmative. Thus, the both discrimination results cannot be compared with each other on an axis of affirmative level illustrated in FIG. 2. In other words, correspondence, such as that “when an affirmative level of 100 is applied to the discrimination result of joy level 100, an affirmative level of 80 is applied to the discrimination result of astonishment level 100”, is hard to be recognized.

FIG. 3 is a diagram illustrating a feature space where six-classes (N=6) are defined. A feature vector of a learning sample is represented by variable quantities (x₁, x₂). In FIG. 3, each of classes C1 to C6 is represented by a circle with a broken line. An average vector of feature vectors of learning samples, which have been classified as a corresponding class, is indicated by a central point of the circle. A radius of a circle is 50, which is the same for each class.

Assume here a two-classes discrimination problem (M=2) that the classes C1 to C3 are classified as positive classes while the classes C4 to C6 are classified as negative classes.

The positive class is a class to which data to be detected is classified. For example, in the two-classes discrimination problem “whether a facial expression is affirmative” as described above, an image is classified as the positive class, which is discriminated that a facial expression of an objected person in the image is affirmative.

On the other hand, the negative class is a class to which data not to be detected is classified. For example, in the two-classes discrimination problem “whether a facial expression is affirmative” described above, an image is classified as the negative class, which is discriminated that a facial expression of an objected person is not affirmative.

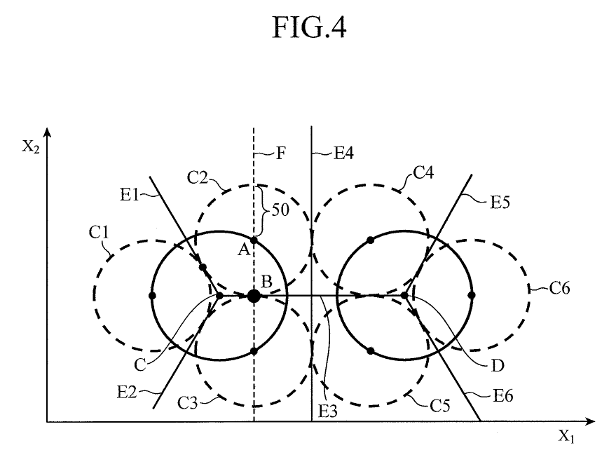

FIG. 4 is a diagram illustrating the feature space in FIG. 3 where discrimination boundaries are set among classes.

A discrimination boundary is a boundary where a class, to which data is classified in the feature space, is shifted to another. Discrimination boundaries E1 to E6 being boundaries among the classes C1 to C6 are set.

A six-classes discrimination problem is solved here by applying the nearest neighbor method. Therefore, it is determined which of average vectors in the classes C1 to C6 is close to a feature vector of a learning sample, and also determined a label of the closest class as the discrimination result of the learning sample.

A distance between the discrimination boundary defined by a line segment as illustrated in FIG. 4 and a feature vector of a learning sample is used to find the certainty factor for comparing discrimination results. For instance, a feature vector of a point A corresponds to an average vector of the class C2, and a distance to the point A from a contact point between the circle of the class C2 and each circle of the classes C1 and C3 is 50. Accordingly, the feature vector of the point A is data having a certainty factor of 50 in the class C2.

A point B is a contact point between the circle of the class C2 and the circle of the class C3. Thus, a feature vector of the point B is data having a certainty factor of 0 in the class C2 or C3. Since the certainties relating to these two classes are equal, it is not possible to determine, by means of the nearest neighbor method, which of the class C2 or the class C3 the point B belongs to.

When the two-classes discrimination problem is assumed such that, the classes C1 to C3 are classified as a positive class while the classes C4 to C6 are classified as a negative class, the central point of an average vector of the positive class is a point C and the central point of the average vector of the negative class is a point D.

Therefore, E4 is set as a discrimination boundary between the positive class and the negative class in the two-classes discrimination problem.

Furthermore, it is assumed that a distance from the discrimination boundary E4 is specified as a certainty factor. In this assumption, the feature vector of the point A being data having a certainty factor of 50 in the class C2 and the feature vector of the point B being data having a certainty factor of 0 in the class C2 or C3 through the six-classes discrimination are classified as data having the same certainty factor of 50 in the two-classes discrimination problem.

In other words, feature vectors of respective points on a line segment F, which is parallel to the discrimination boundary E4, have the same certainty factor in the two-classes discrimination problem. Therefore, it is not possible to define correspondence between a result of the six-classes discrimination and a result of a two-classes discrimination.

In the example in FIG. 4, there is a single discrimination boundary between two classes. However, in practice, M may be 3 or more and less than N, and a plurality of discrimination boundaries are set. Thus, positional relations among classes become complicated.

Also in this case, it is required to compare respective discrimination results in the N-classes discrimination problem by a discrimination criterion of the M-classes discrimination problem, thus resulting in a disadvantage that a correspondence between a result of the N-classes discrimination and a result of the M-classes discrimination cannot be defined.

In contrast, the learning device according to the present invention is configured to reclassify learning samples, which have been classified into the respective classes by the N-classes discrimination, into classes for the M-classes discrimination, and to learn a discriminator for performing the M-classes discrimination based on the reclassified learning samples. This configuration is capable of learning a discriminator for performing discrimination through a discrimination criterion of the M-classes discrimination from a learning sample classified into classes in the N-classes discrimination. Details will be described below.

FIG. 5 is a block diagram illustrating a functional configuration of a learning discrimination system 1 according to the Embodiment 1 of the invention. The learning discrimination system 1 performs discrimination processing by pattern discrimination, such as facial expression discrimination and object detection. The learning discrimination system 1 includes a learning device 2, a storage device 3, and a discrimination device 4.

The learning device 2 according to the Embodiment 1 includes a learning sample collector 2a, a classifier 2b, and a learner 2c. The storage device 3 stores a discriminator learned by the learning device 2. The discrimination device 4 discriminates data to be discriminated by using the discriminator learned by the learning device 2. The discrimination device 4 includes a feature extractor 4a and a discriminator 4b.

Note that, in FIG. 5, a case where the learning device 2 and the discrimination device 4 are separate devices is illustrated. Alternatively, a single device having functions of the both devices may be employed.

In the learning device 2, the learning sample collector 2a is a component for collecting learning samples, and collects the ones from an external storage device, such as a video camera or a hard disk drive.

A learning sample includes a pair comprising a feature vector extracted from data to be learned and a label accompanying the feature vector. Data to be learned may be multimedia data such as image data, video data, sound data, and text data.

A feature vector is data representing feature quantity of data to be learned. When data to be learned is image data, the image data may be used as a feature vector.

Alternatively, processed data obtained by performing feature extraction processing, such as a first order differential filter or an average value filter, on the image data may be used as a feature vector.

A label is information for discriminating a class where a learning sample belongs to. For example, a label “dog” is given to a class of image data whose object is a dog.

Learning samples have been classified into N classes through N-classes discrimination, where N takes a natural number of 3 or more.

Note that a learning sample may be a discrimination result obtained by the discrimination device 4 through the N-classes discrimination.

The classifier 2b reclassifies the learning samples collected by the learning sample collector 2a into classes applied to the M-classes discrimination, where M is smaller than N. M takes a natural number of 2 or more and less than N.

The classifier 2b reclassifies the learning samples into classes having a corresponding label in the M-classes discrimination based on reference data specifying correspondence between labels of classes for the N-classes discrimination and labels of classes in the M-classes discrimination.

In this manner, based on reference data specifying correspondence among labels, the classifier 2b allocates, to a corresponding label, a label of a class to which a learning sample has been classified from among labels of classes for the M-classes discrimination. The learning sample is classified as a class having a label allocated in the above-explained manner.

By performing allocation and classification of labels in the above-described manner on all learning samples, learning samples, which have been classified into the respective classes through the N-classes discrimination, are reclassified into classes for the M-classes discrimination.

Based on the learning samples reclassified by the classifier 2b, the learner 2c learns a discriminator for performing the M-classes discrimination. Relation among feature vectors and labels of a plurality of learning samples are learned, and a discrimination criterion for the M-classes discrimination is determined. The learning method may be one using a nearest neighbor method or CNN, for example.

When a feature vector of the data to be discriminated is input, the discriminator discriminates a class where data to be discriminated belongs to by using a discrimination criterion of each class in the M-classes discrimination, and outputs the discriminated class.

The storage device 3 stores the discriminator learned by the learning device 2, as described above. The storage device 3 may be implemented by an external storage device such as a hard disk drive.

The storage device 3 may be contained in the learning device 2 or the discrimination device 4.

Note that the learning discrimination system 1 may not include the storage device 3. The storage device 3 can be omitted by directly setting a discriminator on the discriminator 4b of the discrimination device 4 from the learner 2c of the learning device 2.

In the discrimination device 4, the feature extractor 4a extracts a feature vector that is feature quantity of data to be discriminated. The discriminator 4b performs the M-classes discrimination on the data to be discriminated on a basis of the discriminator learned by the learning device 2 and the feature vector collected by the feature extractor 4a.

Specifically, the discriminator 4b discriminates which class the data to be discriminated belongs to by using the discriminator, and outputs a label of the discriminated class as a discrimination result.

The functions of the learning sample collector 2a, the classifier 2b, and the learner 2c in the learning device 2 are implemented by processing circuitry. That is, the learning device 2 comprises processing circuitry for performing processing from step ST1 to step ST3 illustrated in FIG. 7, which will be described later.

The processing circuitry may be dedicated hardware or a central processing unit (CPU) executing a program stored in a memory.

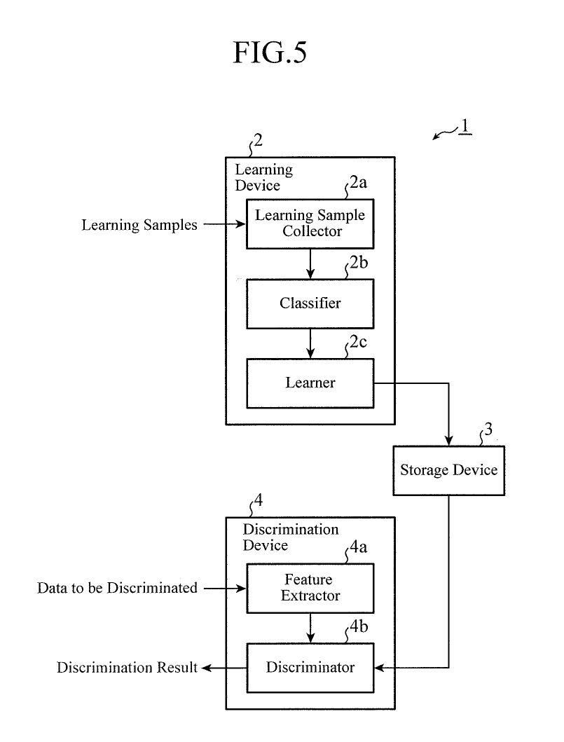

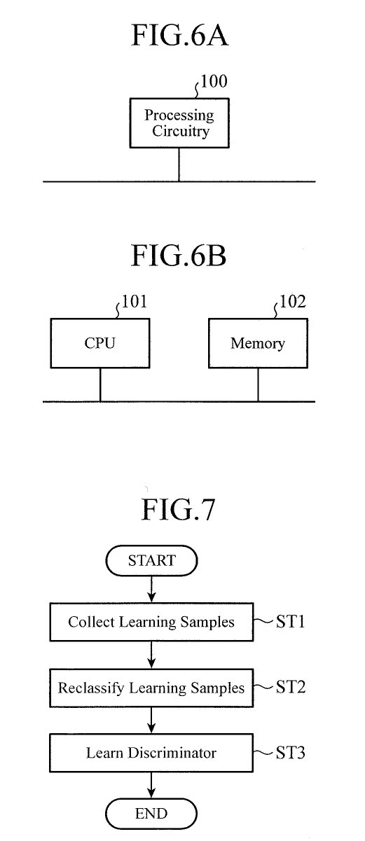

FIGS. 6A and 6B are block diagrams illustrating the hardware constitution of the learning device 2 according to the Embodiment 1. FIG. 6A is a diagram illustrating processing circuitry of hardware implementing functions of the learning device 2. FIG. 6B is a diagram illustrating the hardware constitution that executes software implementing functions of the learning device 2.

As illustrated in FIG. 6A, when the processing circuitry mentioned above is processing circuitry 100 formed by dedicated hardware, the processing circuitry 100 may be a single circuit, a composite circuit, a programmed processor, parallel programmed processor, an application specific integrated circuit (ASIC), a field-programmable gate array (FPGA), or a combination of those.

Each function of the learning sample collector 2a, the classifier 2b, and the learner 2c may be implemented by individual processing circuitry. Alternatively, those functions may be collectively implemented by single processing circuitry.

As illustrated in FIG. 6B, when the processing circuitry is the CPU 101 functions of the learning sample collector 2a, the classifier 2b, and the learner 2c are implemented by software or firmware or a combination of software and firmware.

Software and firmware are described as a computer program and stored in a memory 102. The CPU 101 reads out and executes the program stored in the memory 102 and thereby implements functions of the elements.

That is, the learning device 2 has the memory 102 to store the program which results in the processing steps ST1 to ST3 illustrated in FIG. 7 by the CPU 101. The programs cause a computer to execute procedures or methods of the learning sample collector 2a, the classifier 2b, and the learner 2c.

The memory may be a nonvolatile or volatile semiconductor memory such as a random access memory (RAM), a ROM, a flash memory, an erasable programmable ROM (EPROM), or an electrically EPROM (EEPROM), a magnetic disc, a flexible disc, an optical disc, a compact disc, a mini disc, or a digital versatile disk (DVD).

Note that part of functions of the learning sample collector 2a, the classifier 2b, and the learner 2c may be implemented by dedicated hardware and the others may be implemented by software or firmware.

For instance, the learning sample collector 2a implements the function thereof by the processing circuitry 100 of dedicated hardware while the classifier 2b and the learner 2c implement their functions by the CPU 101 executing a program stored in the memory 102.

In this manner, the processing circuitry is able to implement the functions described above by hardware, software, firmware, or a combination of those.

Similarly to the learning device 2, functions of the feature extractor 4a and the discriminator 4b in the discrimination device 4 may be implemented by dedicated hardware or software or firmware. Part of the functions may be implemented by dedicated hardware and the others may be implemented by software or firmware.

Next, operations will be described.

FIG. 7 is a flowchart illustrating operations of the learning device 2.

The learning sample collector 2a collects learning samples which have been classified into respective classes through N-classes discrimination (step ST1).

For example, an image of a person who looks at an advertisement is given as data to be discriminated, and a discrimination result classified as one of seven classes (N=7) (joy, sadness, anger, straight face, astonishment, fear, and dislike) are collected as a learning sample.

The classifier 2b reclassifies the learning samples collected by the learning sample collector 2a into classes for M-classes discrimination (step ST2).

For example, the learning samples classified into seven classes are reclassified into two classes (M=2) (affirmative and negative).

Reclassification is executed based on correspondence among labels.

For example, reference data is preset in the classifier 2b, which indicates correspondence between labels of classes for the seven-classes discrimination and labels of classes for the two-classes discrimination.

The classifier 2b allocates a label of a class of each learning sample to a corresponding label among labels of the classes for the two-classes discrimination based on the reference data. The learning samples are classified as a class whose label has been allocated by the classifier 2b.

Performing such reallocation and classification of labels on all learning samples results in reclassifying the learning samples classified into respective classes of the seven-classes discrimination into classes of the two-classes discrimination.

Correspondence between labels of classes for the N-classes discrimination and labels of classes for the M-classes discrimination is different depending on an object of an application for performing information processing using the learning discrimination system 1.

For example, it is assume that an object of an application is detection of an affirmative facial expression from an image in which a person looking at an advertisement is captured. In this assumption, labels of “joy”, “astonishment”, and “straight face” in facial expression discrimination are associated with a label of “affirmative” while labels of “sadness”, “anger”, “fear”, and “dislike” are associated with a label of “negative”.

For another example, it is assumed that an object of an application is detection from an image, in which a person watching a horror film is captured, whether or not the person feels fear. In this assumption, labels of “fear”, “dislike”, “sadness”, “anger”, and “astonishment” in facial expression discrimination are associated with a label of “positive in fear effect” while labels of “joy” and “straight face” are associated with a label of “negative in fear effect”.

Note that correspondence among labels may be automatically determined by the learning device 2 or may be set by a user. Specifically, the classifier 2b may associate labels of classes for M-classes discrimination with labels of classes for N-classes discrimination by analyzing a processing algorithm of an application and specifying the M-classes discrimination performed by the application. Alternatively, a user may set correspondence among labels through an input device.

Thereafter, the learner 2c learns a discriminator for performing the M-classes discrimination based on the learning samples reclassified by the classifier 2b (step ST3).

For example, when a feature vector of data to be discriminated is input, a discriminator is generated, which is for discriminating a class, to which the data to be discriminated belongs from among classes for the two-classes discrimination (affirmative and negative). The discriminator obtained in the above manner is stored in the storage device 3.

It is assumed that an affirmative facial expression is detected from an image of a person looking at an advertisement. In this assumption, when an image in which the person looking at the advertisement is captured is input, the feature extractor 4a of the discrimination device 4 extracts a feature vector from the image.

The discriminator 4b discriminates which of the affirmative class or the negative class the image belongs to on a basis of the discriminator read out from the storage device 3 and the feature vector of the image. The discriminator 4b outputs a label of the discriminated class as a discrimination result.

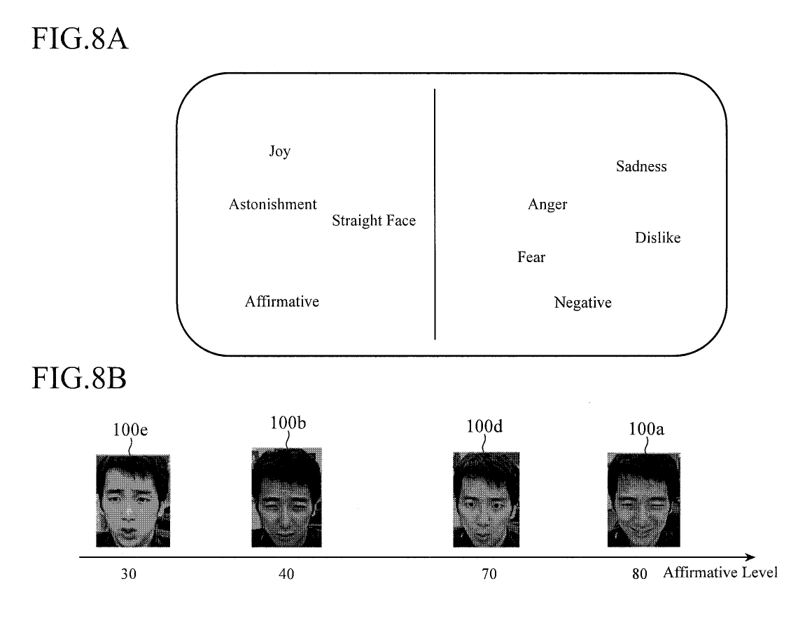

FIGS. 8A and 8B are diagrams illustrating an overview of processing for performing two-classes discrimination using a result of seven-classes discrimination in facial expression discrimination. FIG. 8A is a diagram illustrating learning samples reclassified from seven classes (joy, sadness, anger, straight face, astonishment, fear, and dislike) into two classes (affirmative and negative). FIG. 8B is a diagram illustrating a result of the two-classes discrimination.

In FIG. 8B, an image 100a has been classified as a class of a label “joy”, and a discrimination result of the joy level 80 has been obtained from the image 100a. An image 100b has been classified as a class of a label “sadness”, and a discrimination result of the sadness level 80 has been obtained from the image 100b. An image 100d has been classified as a class of a label “astonishment”, and a discrimination result of the astonishment level 80 has been obtained. An image 100e has been classified as a class of a label “fear”, and a discrimination result of the fear level 80 has been obtained therefrom.

In the learning device 2 according to the Embodiment 1, data having been classified as a corresponding class through the seven-classes discrimination is reclassified as a class for the two-classes discrimination on a basis of correspondence among labels.

For instance, each data formed by a pair of a feature vector and a label for the images 100a and 100d is reclassified as the class of the label “affirmative” by allocating the label “joy” and the label “astonishment” to the label “affirmative” without depending on the joy level of 80 and the astonishment level of 80.

Similarly, each data formed by a pair of a feature vector and a label for the images 100b and 100e is reclassified as the class of the label “negative” by allocating the label “sadness” and the label “fear” to the label “negative” without depending on the sadness level of 80 and the fear level of 80.

Based on the learning samples reclassified into the class of “affirmative” and the class of “negative”, the learning device 2 learns a discriminator having the discrimination criterion that a facial expression is affirmative.

By performing the two-classes discrimination using this discriminator, it becomes possible to compare individual data of the images 100a, 100b, 100d, and 100e, which have been classified into the classes for the seven-classes discrimination, on the basis of the affirmative level of the discrimination criterion for the two-classes discrimination, as illustrated in FIG. 8B.

Specifically, data of the image 100a having a joy level of 80 becomes the one having an affirmative level of 80, and data of the image 100d having an astonishment level of 80 becomes the one having an affirmative level of 70. Data of the image 100b having a sadness level of 80 becomes the one having an affirmative level of 40, and data of the image 100e having a fear level of 80 becomes the one having an affirmative level of 30.

As described above, the learning device 2 according to the Embodiment 1 includes the learning sample collector 2a, the classifier 2b, and the learner 2c.

The learning sample collector 2a collects learning samples which have been classified into respective classes through N-classes discrimination. The classifier 2b reclassifies the learning samples collected by the learning sample collector 2a into classes for M-classes discrimination, where M is smaller than N. The learner 2c learns a discriminator for performing the M-classes discrimination on the basis of the learning samples reclassified by the classifier 2b.

In this manner, the learning samples having been classified into the respective classes through the N-classes discrimination are reclassified into classes of the M-classes discrimination, and, after that, the discriminator of the M-classes discrimination is learned. Therefore, it is capable of comparing results of the N-classes discrimination on the basis of a discrimination criterion of the M-classes discrimination problem, where M is smaller than N.

In the learning device 2 according to the Embodiment 1, the classifier 2b reclassifies the learning samples collected by the learning sample collector 2a into a class having a corresponding label in the M-classes discrimination on the basis of the reference data representing correspondence between a label of a class in the N-classes discrimination and a label of a class in the M-classes discrimination. Therefore, it is possible to integrate classes for the N-classes discrimination with a corresponding class for the M-classes discrimination on the basis of the correspondence defined in the reference data.

Furthermore, the learning discrimination system 1 according to the Embodiment 1 comprises the learning device 2 and the discrimination device 4. The discrimination device 4 discriminates a class, to which data to be discriminated belongs, from among classes of the M-classes discrimination by using the discriminator learned by the learning device 2.

By employing this configuration, similar effects to the above is obtained. Moreover, the M-classes discrimination can be performed with the M-classes discriminator learned as a result of the N-classes discrimination.

### Embodiment 2

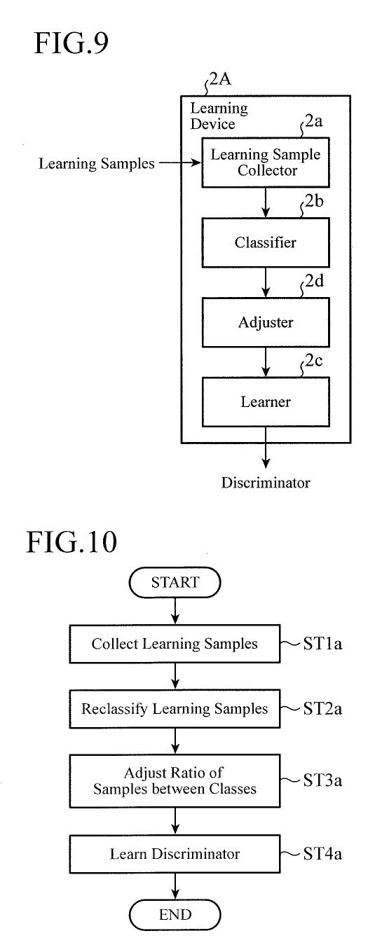

FIG. 9 is a block diagram illustrating a functional configuration of a learning device 2A according to Embodiment 2 of the invention. In FIG. 9, the same component as that in FIG. 1 is denoted with the same symbol and descriptions thereon are omitted.

A learning device 2A includes a learning sample collector 2a, a classifier 2b, a learner 2c, and an adjuster 2d. The adjuster 2d adjusts the ratio of the quantity of samples between classes of the learning samples, which have been reclassified by the classifier 2b, to decrease erroneous discrimination in the M-classes discrimination.

Similarly to the Embodiment 1, functions of the learning sample collector 2a, the classifier 2b, the learner 2c, and the adjuster 2d in the learning device 2A may also be implemented by dedicated hardware or by software or firmware.

Part of the functions may be implemented by dedicated hardware while the other parts may be implemented by software or firmware.

Next, operations will be described.

FIG. 10 is a flowchart illustrating operations of the learning device 2A. Processing of steps ST1a and ST2a in FIG. 10 is similar to the processing of steps ST1 and ST2 in FIG. 7 and thus descriptions thereon are omitted.

The adjuster 2d adjusts the ratio of the quantity of samples between classes of the learning samples, which have been reclassified in step ST2a, to decrease erroneous discrimination in the M-classes discrimination (step ST3a).

The learner 2c learns a discriminator based on the learning samples which have been adjusted by the adjuster 2d (step ST4a).

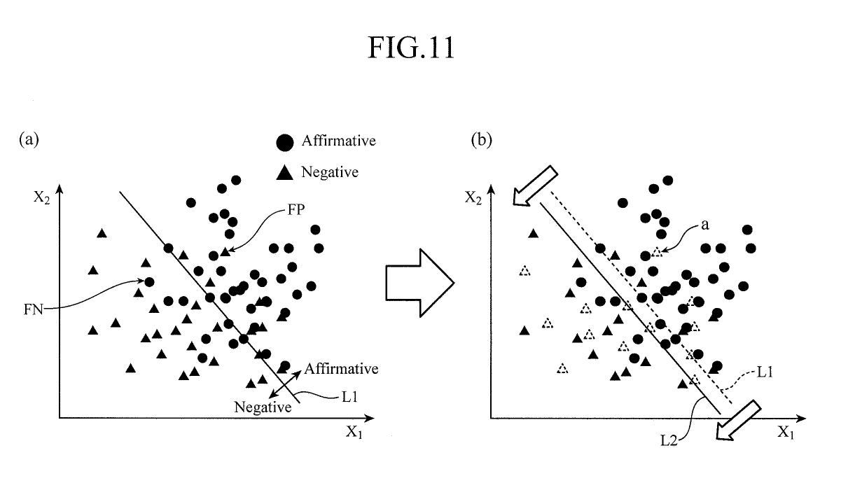

FIGS. 11A and 11B are diagrams illustrating processing for adjusting the ratio of the quantity of learning samples between classes. The diagrams illustrate learning samples which are distributed on the affirmative class and the negative class.

If assuming that the learning is performed without adjusting the ratio of the quantity of learning samples between the affirmative class and the negative class, a discrimination boundary L1 illustrated in FIG. 11A is obtained.

An affirmative sample refers to a learning sample to be discriminated as belonging to the affirmative class, and a negative sample refers to a learning sample to be discriminated as belonging to the negative class.

By performing the leaning without adjusting the ratio of the quantity of learning samples, quantity of the negative samples beyond the discrimination boundary L1, which are erroneously discriminated as belonging to the affirmative class (false positive; hereinafter referred to as “FP”), is fixed. In addition, quantity of the affirmative samples beyond the discrimination boundary L1, which are erroneously discriminated as belonging to the negative class (false negative; hereinafter referred to as “FN”), is also fixed.

In order to improve discrimination accuracy, there is a need to perform learning so as to decrease the FNs and the FPs.

For the reason above, the adjuster 2d thins out negative samples on the affirmative class and the negative class as illustrated by an arrow “a” in FIG. 11B, for example. By performing learning with adjustment of the ratio of the quantity of learning samples between the affirmative class and the negative class, the discrimination boundary moves from L1 to L2. According to the discrimination boundary L2, more learning samples are determined as belonging to the affirmative class than with the discrimination boundary L1, and thus the discrimination criterion of the M-classes discrimination is adjusted to have tendency of affirmative discrimination.

Note that there may be cases where no discrimination boundary is set between classes in machine learning. In this case, success or failure of class discrimination of a learning sample is determined based on a discrimination criterion between classes. Thus, the effect as described above can be obtained in this case.

As methods for adjusting the ratio of the quantity of samples, for example, from a state where all learning samples classified to the respective classes are selected, repeating operation of randomly canceling selecting of one of the samples until a predetermined number of samples remain. Alternatively, randomly selecting a sample from among all samples classified into respective classes may be repeated until the quantity of samples to be left as learning samples reaches a predetermined quantity of samples. Furthermore, a method called as a bootstrap method may be employed.

As described above, the learning device 2A according to the Embodiment 2 includes the adjuster 2d to adjust the ratio of the quantity of samples between classes of the learning samples reclassified by the classifier 2b such that erroneous discrimination in the M-classes discrimination decreases. The learner 2c learns the discriminator based on the learning samples whose ratio of the quantity between classes has been adjusted by the adjuster 2d.

According this configuration, it is possible to adjust a discrimination criterion to have tendency of affirmative discrimination. Therefore, it is capable of decreasing erroneous discrimination between classes and improving a discrimination accuracy of the M-classes discrimination.

Within the scope of the present invention, the present invention may include a flexible combination of the respective embodiments, a modification of any component of the respective embodiments, or omission of any component in the respective embodiments.

The learning device according to the present invention is capable of learning the discriminator for solving the M-classes discrimination problem using individual discrimination results of the N-classes discrimination problem as learning samples. Thus, it is applicable to an information processing system that performs various type of discrimination through pattern discrimination such as facial expression discrimination and object detection.

### REFERENCE SIGNS LIST

1: Learning discrimination system, 2 and 2A: learning device, 2a: learning sample collector, 2b: classifier, 2c: learner, 2d: adjuster, 3: storage device, 4: discrimination device, 4a: feature extractor, 4b: discriminator, 30: affirmative level, 100: processing circuitry, 100a to 100e: image, 101: CPU, and 102: memory

1. A learning device comprising:
a learning sample collector to collect learning samples which have been classified into respective classes through N-classes discrimination (N is a natural number of 3 or more);
a classifier to reclassify the learning samples collected by the learning sample collector into classes applied to M-classes discrimination, where M is smaller than N (M is a natural number of 2 or more and is less than N); and
a learner to learn a discriminator for performing the M-classes discrimination on a basis of the learning samples reclassified by the classifier.

2. The learning device according to claim 1, further comprising an adjuster to adjust a ratio of quantity of samples between classes of the learning samples reclassified by the classifier to decrease erroneous discrimination in the M-classes discrimination,
wherein the learner is configured to learn the discriminator on a basis of the learning samples whose ratio of quantity of samples between classes have been adjusted.

3. The learning device according to claim 1, wherein the classifier is configured to reclassify the learning samples collected by the learning sample collector on a basis of data indicating correspondence between a label of classes applied to the N-classes discrimination and a label of classes applied to the M-classes discrimination, the leaning samples being reclassified into classes each of which has a corresponding label of the M-classes discrimination.

4. A learning discrimination system comprising:
a learning device including
a learning sample collector to collect learning samples which have been classified into respective classes through N-classes discrimination (N is a natural number of 3 or more),
a classifier to reclassify the learning samples collected by the learning sample collector into classes applied to M-classes discrimination, where M is smaller than N (M is a natural number of 2 or more and is less than N), and
a learner to learn a discriminator for performing the M-classes discrimination on a basis of the learning samples reclassified by the classifier; and
a discrimination device including
a feature extractor to extract feature quantity of data to be discriminated, and
a discriminator to perform the M-classes discrimination on the data to be discriminated on a basis of the discriminator learned by the learning device and the feature quantity extracted by the feature extractor.

5. The learning discrimination system according to claim 4, wherein
the learning device has an adjuster to adjust a ratio of quantity of samples between classes of the learning samples reclassified by the classifier to decrease erroneous discrimination in the M-classes discrimination, and
the learner is configured to learn the discriminator on a basis of the learning samples whose ratio of quantity of samples between classes have been adjusted.
